(19) United States
(12) Patent Application Publication
(10) Pub. No.: US 2012/0202100 A1
(43) Pub. Date: Aug. 9, 2012

(54) THIN BATTERY WITH IMPROVED INTERNAL RESISTANCE

(75) Inventors: Eduard Pytlik, Ellwangen (DE); Martin Krebs, Rosenberg (DE)

(73) Assignee: VARTA MICROBATTERY GMBH, Ellwangen (DE)

(21) Appl. No.: 13/499,812

(22) PCT Filed: Oct. 5, 2010
(86) PCT No.: PCT/EP10/64801

§ 371 Date: Apr. 2, 2012

(30) Foreign Application Priority Data
Oct. 8, 2009 (DE) 10 2009 049 561.4
Oct. 8, 2009 (DE) 10 2009 049 562.2

(51) Int. Cl. H01M 4/00; H01M 6/40; H01M 6/46

(52) U.S. Cl. 429/124; 429/162; 429/149

(57) ABSTRACT

A battery includes a flat positive and a flat negative electrode separated by a gap, arranged alongside one another on a flat substrate and connected to one another via an ion-conducting electrolyte, wherein a ratio of thickness of at least one of the electrodes to a minimum width of the gap is 1:10 to 10:1.

### RELATED APPLICATIONS

This is a §371 of International Application No. PCT/EP2010/064801, with an international filing date of Oct. 5, 2010 (WO 2011/042418 A1, published Apr. 14, 2011), which is based on German Patent Application Nos. 10 2009 049 561.4, filed Oct. 8, 2009, and 10 2009 049 562.2, filed Oct. 8, 2009, the subject matter of which is incorporated by reference.

### TECHNICAL FIELD

This disclosure relates to a battery having a flat positive and a flat negative electrode which, separated by a gap, are arranged alongside one another on a flat substrate and are connected to one another via an ion-conducting electrolyte.

### BACKGROUND

Widely differing types of batteries are known. Inter alia, so-called “printed” batteries exist, in which at least some, and preferably all, of the functional parts, in particular the electrodes and output-conductor structures, are formed by printing on an appropriate substrate.

In conventional printed batteries, the functional parts of those batteries are located in various levels. Traditionally, two output-conductor levels, two electrode levels and a separator level are provided, and are in the form of a stack on a substrate. A battery such as this with a stack structure is described, for example, in U.S. Pat. No. 4,119,770.

Batteries having a stack structure have a good load capability and a relatively low internal resistance. However, the sequential production of a stack such as this requires numerous individual steps, also including time-consuming drying steps. Furthermore, batteries having electrodes arranged in the form of a stack, having separator levels and having output-conductor levels have a relatively high physical form and little mechanical flexibility. In general, they are not suitable for fitting to thin, flexible substrates such as films.

WO 2006/105966 discloses printed batteries distinguished by a very small physical height and/or thickness and a very simple construction. This is because the described batteries have electrodes arranged alongside one another on a substrate. In this arrangement, the functional parts of the battery are essentially now simply arranged one above the other in three levels (an output-conductor level, an electrode level and an electrolyte level). Therefore, overall, this results in a comparatively highly flexible design, which is very flat.

The advantage of the comparatively thin design results, however, in additional cost. Since, during operation, the ions have to migrate not only through a thin separator level, as is the case with electrodes in the form of stacks, but, instead of this, in some cases have to travel over very long distances via the electrolyte layer, the internal resistance of a battery having electrodes arranged in parallel and alongside one another rises severely during operation. The current load capability also, of course, falls in parallel with this.

It could therefore be helpful to provide a battery distinguished by a physical form which is as flat and flexible as possible, while at the same time, however, not having the described problems of known flat batteries, or having them only to a greatly reduced extent.

### SUMMARY

We provide a battery including a flat positive and a flat negative electrode separated by a gap, arranged alongside one another on a flat substrate and connected to one another via an ion-conducting electrolyte, wherein a ratio of thickness of at least one of the electrodes to a minimum width of the gap is 1:10 to 10:1.

### BRIEF DESCRIPTION OF THE DRAWINGS

FIG. 1 shows two rectangular electrodes (positive and negative) fitted alongside one another on a flat substrate, in the form of a plan view, according to the prior art.

FIG. 2 shows one example of the electrodes of one of our batteries with a pattern in the form of a comb (schematic illustration).

FIG. 3 shows an example of the electrodes of one of our batteries with the configuration in the form of strips (schematic illustration).

FIG. 4 shows examples of our battery (cross section, schematic illustration).

FIG. 5 shows examples of electrodes in the form of strips of our battery with a triangular, sawtooth, wave and spiral geometry (schematic illustration).

FIG. 6 shows a further example of the electrodes of our battery with a pattern in the form of a comb (schematic illustration).

### DETAILED DESCRIPTION

Our batteries have a flat positive and a flat negative electrode arranged alongside one another on a flat substrate, with the electrodes being separated from one another by a gap. The substrate is electrically non-conductive, as a result of which there is no direct electrical connection between the electrodes. However, they are connected to one another via an ion-conducting electrolyte. Therefore, for example, lithium ions can migrate via the electrolyte from one electrode to the other.

The battery is particularly characterized in that at least the thickness of one of the two electrodes, preferably the thickness of both electrodes, is in a specific ratio to the minimum width of the gap. This is because the quotient of the thickness and the minimum width is always between 1:10 and 10:1, preferably between 0.5:1 and 5:1, in particular between 0.5:1 and 2:1, particularly preferably between 1:1 and 2:1. Both the quotient of the thickness of the positive electrode and the minimum gap width as well as the quotient of the thickness of the negative electrode and the minimum gap width are preferably within these ranges.

We found that the internal resistance of batteries having electrodes arranged alongside one another on a flat substrate can be reduced considerably by controlling the ratio of the electrode thicknesses and gap width as stated. In some cases, an internal resistance which has been decreased by more than a third has been observed, which, a priori, would not have been expected. The current load capability of the batteries is correspondingly greatly improved in comparison to that of comparable traditional batteries.

The areas which the electrodes of the battery occupy on the substrate are each defined by a circumferential boundary line. In the case of each of the electrodes, at least part of the boundary line faces a or the corresponding electrode of opposite polarity. Those “parts” of the boundary line which “face” the electrode of opposite polarity in this case mean, in particular, those parts in which each point on the line can be connected to the boundary line of an electrode of opposite polarity by a straight line, in particular, a straight line at right angles to the boundary line at this point without in the process touching or intersecting one of the boundary lines at more than one point. It is preferable for these parts of the boundary lines to also define the gap between the electrodes. More precisely, the gap which separates the flat positive electrode and the flat negative electrode from one another is defined as the largest possible area not covered with electrode material on the substrate which can be included by straight lines between the boundary lines which connect a point on the boundary line of one electrode to a point on the boundary line of the other electrode, without in this case touching or intersecting one of the boundary lines at more than one point.

By way of example, more than one circumferential boundary line may be feasible, for example, in the case of a concentric arrangement of a plurality of annular or circular electrodes. In an arrangement such as this, it can then also be possible for the boundary line of one electrode to completely face, that is to say not only partially, the associated electrode of opposite polarity.

The minimum width of the gap that has been mentioned is intended to mean the gap width at the point of the shortest possible ion path between the two electrodes. The minimum width of the gap therefore corresponds to the shortest distance between the boundary lines which define the electrodes.

Preferably, the electrodes of the battery each have an essentially uniform thickness over their entire area, which thickness, however, may vary slightly in some circumstances, possibly depending on the production process. In the case of one preferred procedure for exactly determining the thickness of the electrodes, the electrodes are preferably cut once longitudinally or laterally to be precise such that this results in a maximum cut length (in the case of a rectangular electrode, the cut is, for example, preferably in the form of a diagonal). The cut is then subdivided in each case into two areas of equal length at whose center the electrode thickness is in each case measured. The resultant values are then averaged.

The gap between the electrodes preferably has an essentially uniform gap width. This is intended to mean that the shortest possible ion path between the two electrodes in the area of the gap is essentially always the same, preferably over at least 95% of the length of the gap, in particular over the entire length of the gap. Ideally, the gap width along the gap varies by no more than 25%, in particular by less than 10%, particularly preferably by less than 5% (in each case with respect to the minimum gap width). The minimum width defined above then exists not only between two points on the boundary lines of the electrodes, but in fact the electrodes are preferably at an essentially constant distance from one another along the mutually facing parts of the boundary lines which form the gap. Normally, the gap widths are between 10 μm and 2 mm. Within this range, gap widths of between 50 μm and 1 mm are particularly preferred, particularly preferably between 50 μm and 500 μm.

Furthermore, it is particularly preferable for the positive and the negative electrodes of the battery to have essentially the same thickness. The quotient of the thickness of the positive electrode and the minimum gap width is therefore preferably identical to the quotient of the thickness of the negative electrode and the minimum gap width.

Preferred electrode thicknesses for the positive and negative electrodes are preferably in the range of 10 μm to 500 μm, particularly preferably 10 μm to 250 μm, in particular 50 μm to 150 μm.

Frequently, materials for the negative electrodes of batteries have a higher energy density than comparable materials for the positive electrode. It is correspondingly preferable for the positive electrode to occupy a larger area than the negative electrode on the substrate. In particular, this applies, of course, when the positive electrode and the negative electrode have comparable or the same thicknesses.

Particularly preferably, the electrodes are in the form of strips, at least in subareas, preferably completely, in particular rectangular strips or strips in the form of ribbons. In this case, the strips preferably have an essentially uniform width, essentially over their entire length.

By way of example, the electrodes may each comprise a plurality of sections in the form of strips arranged parallel to one another. These may, for example, be integrally formed on a common lateral web aligned orthogonally to the strips and preferably likewise in the form of a strip or ribbon, thus resulting overall in a “comb-like” configuration. Two such electrodes may, of course, be arranged “such that they engage in one another” on a substrate without any problems (presupposed dimensions matched to one another, of course) specifically by arranging the lateral webs parallel to one another, in which case one strip of the electrode of opposite polarity then in each case comes to rest between two strips, arranged parallel, of an electrode.

The advantage of an electrode configuration such as this is that the length of the gap between the electrodes rises sharply in proportion to the area of the electrodes, which in turn on average makes it possible to reduce the distance over which the ions have to travel from one electrode to the other. Alternatively, to be more precise, it may be highly advantageous for the ratio of the length of that part of the boundary line of an electrode which faces the corresponding electrode of opposite polarity to the overall length of the boundary line to be as high as possible. In combination with the selected ratio of the electrode thicknesses and gap width, this allows drastic improvements to be achieved in terms of the current load capability of the battery.

Preferably, the quotient of the length of that part of the boundary line of an electrode which faces the corresponding electrode of opposite polarity to the overall length of the boundary line is more than 0.4. Preferably, it is more than 0.5, particularly preferably more than 0.75, and in particular more than 0.9.

In particularly preferred examples of the battery, there is also an optimum ratio for the ratio of the width of the strips to the width of the gap between the electrodes, in particular between the electrodes in the form of strips. Preferably, the quotient of the width of the strips to the width of the gap between the electrodes is 0.5:1 to 20:1. Within this range, values of 0.5:1 to 10:1 are further preferred.

Normal strip widths preferably vary in the range of 0.05 mm to 10 mm, in particular 0.05 mm to 2 mm.

The ratio of the length of the strips to their width is preferably in the range of 2:1 to 10 000:1, in particular 10:1 to 1 000:1. In other words, the length of the strips is preferably greater than that of their width by a factor of between two and ten thousand.

Preferably, the battery may comprise more than one positive electrode or more than one negative electrode, particularly preferably also more than one positive and more than one negative electrode. The ratios as defined above of the electrode thickness to the minimum width of the gap and of the length of that part of the boundary line of an electrode which faces the corresponding electrode of opposite polarity to the overall length of the boundary line preferably apply to all of these electrodes.

Thus, in particular, it is possible for a plurality of positive and negative electrodes in the form of strips to be arranged alongside one another on a substrate, in particular arranged parallel to one another. An alternating arrangement is preferred such that a positive electrode is always at least adjacent to a negative electrode and vice versa. The gap width between the adjacent electrodes is in this case preferably essentially constant. By way of example, two negative electrodes in the form of strips and one positive electrode in the form of a strip may be arranged parallel to one another on the substrate, with the positive electrode arranged between the negative electrode strips, and with the gap on both sides of the positive electrode having an essentially uniform width over its entire length.

If the battery comprises more than one electrode of the same polarity, then these electrodes are preferably connected to one another via conductor tracks. Conductor tracks such as these are used as output conductors/collectors and it is sensible to arrange them in a preferred manner between the flat substrate and the electrodes. Conductor tracks such as these can be produced, for example, by printing. It is, of course, also possible to specifically metalize the substrate to produce the conductor tracks. For example, conductor tracks can be applied to the substrate electrochemically or by sputtering.

As already mentioned, the electrodes are connected to one another via an electrolyte layer. Suitable electrolytes are known. It is preferable to use a gel-like electrolyte as the ion-conducting electrolyte. If appropriate, this can also be applied to the substrate by printing. Ideally, it should at least partially cover the electrodes to provide adequate conductivity. Preferably, the electrolyte covers the positive and the negative electrodes on the substrate completely, and may even overhang the corresponding boundary lines of the electrodes.

The maximum thickness of the electrolyte layer (measured from the substrate) preferably varies in the range of 10 μm to 500 μm, in particular 50 μm to 500 μm.

In particular, the electrodes of the battery are preferably printed onto the substrate. The battery is therefore preferably a printed battery in which at least some and preferably all of the functional parts, in particular the electrodes, the output conductors and/or the electrolyte, are formed by printing on a corresponding substrate.

Normal electrode materials in the form of a paste which can be printed are known. These can be applied to appropriate substrates comparatively easily using standard methods, for example, a screen-printing method to be precise, in particular, as thin layers with an essentially uniform thickness, corresponding to the above.

Our batteries can be transferred to widely differing electrochemical systems. Preferably, the battery is, for example, a zinc/manganese-dioxide battery or a nickel/metal-hydride battery. Correspondingly, the battery may be a primary battery and a secondary battery.

By way of example, the substrate of the battery may be a plastic film. However, in principle, all electrically non-conductive materials can be used, for example, including paper or wood.

Preferably, the battery may comprise a second substrate, in particular, as a covering layer, which is preferably arranged above the level of the electrolyte and at least partially covers the electrolyte and the electrodes. This cover layer which may, for example, be a plastic film has a protective function for the electrolyte and the electrodes. Furthermore, the cover layer in the battery provides improved mechanical robustness overall. The first and the second substrate may be composed of the same material.

As already mentioned above, the areas of the electrodes on the substrate are each defined by a circumferential boundary line in which case, for each of the two electrodes, at least a part of the boundary line faces at least one corresponding electrode of opposite polarity. Particularly when the battery is in the form of a printed battery, it is preferable at least for one of the two electrodes and preferably for both electrodes, for at least this part of the boundary line to have a non-linear profile. This applies in particular when the electrodes of the battery or at least parts of the electrodes are in the form of strips, as has been described above. In this case, “non-linear profile” is intended to mean that the part of the boundary line (as an entity) is not a straight line, although, however, it may actually have straight subsections.

Particularly in these constructions, the quotient of the length of that part of the boundary line of an electrode which faces the corresponding electrode of opposite polarity to the overall length of the boundary line is above the limit values already mentioned above.

In principle, when printing batteries, the electrodes may have any desired shape. Even complex patterns and structures can be produced without any problems. Traditional electrode geometries are described, for example, in WO 2006/105966. There, simple rectangular electrodes are fitted to a substrate parallel alongside one another, separated by a gap. When current flows, most of the ions have to travel over very long distances, however, thus constricting the current flow. Only a small proportion of ions have only a short path through the gap, and most have to travel over a considerably longer path through the electrolyte via the electrodes. If the gap-forming boundary lines are designed to be non-linear, this proportion can, however, be considerably increased so this also results in the length of the gap between the electrodes rising in comparison to the area of the electrodes, which in turn makes it possible on average to reduce the distance which the ions have to travel from one electrode to the other. This is also clear from the drawings.

Preferably, at least a part of the boundary line of at least one, and preferably of both electrodes has a rectangular, triangular, wave-like, spiral or sawtooth-like profile. Particularly preferably, these parts engage in one another such that the resultant gap between the electrodes has an essentially uniform gap width. One precondition for them engaging in one another is, of course, that the respective dimensions of the corresponding electrodes are also matched to one another.

Particularly preferably, the electrodes or at least parts of the electrodes, in particular those parts of the electrodes in the form of strips correspondingly have a rectangular, triangular, wave-like, spiral or sawtooth-like profile.

Combinations of the patterns mentioned may, of course, also be implemented. Preferably, however, the electrodes have one of the profiles mentioned in their entirety.

Further features will become evident from the following description of preferred examples and from the drawings. In this case, the individual features may each be implemented in their own right or in groups, combined with one another, in an example. The described preferred examples are only for explanatory purposes and to assist in understanding, and should in no way be considered restrictive. The drawings described in the following text are also part of the description, and they are hereby included by explicit reference.

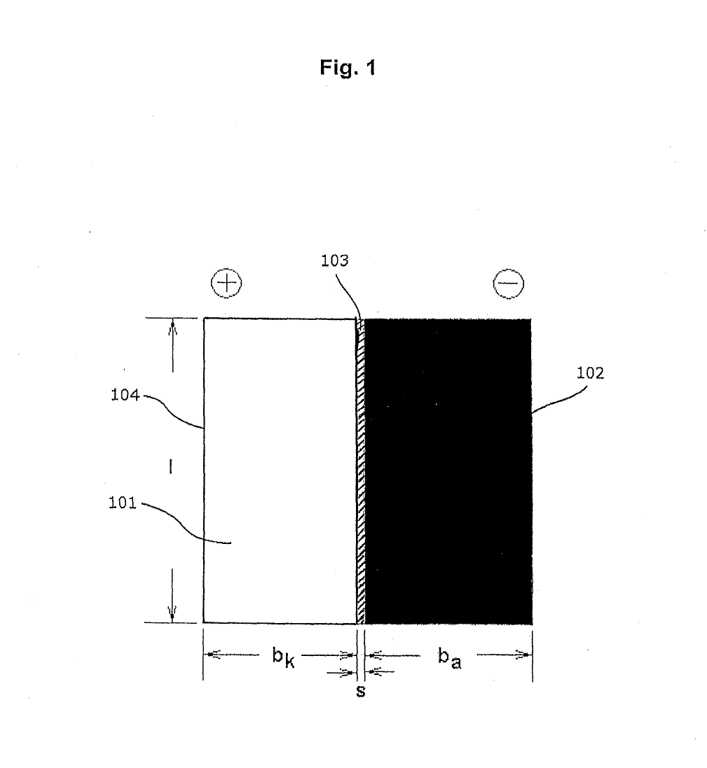

FIG. 1 shows two electrodes 101 and 102 (positive and negative) which have been printed onto a flat substrate alongside one another, in the form of a plan view, according to the prior art, as described by way of example, in WO 2006/105966. The positive electrode 101 is shown in white, and the negative electrode 102 is shown in black. The areas of the electrode are each defined by a circumferential boundary line. The electrodes are each rectangular and are separated by a gap 103. By definition, the gap is the largest possible area not covered with electrode material which can be enclosed by straight lines between the boundary lines of the electrodes, connecting a point on the boundary line of one electrode to a point on the boundary line of the other electrode, without in this case touching or intersecting one of the boundary lines at more than one point. This area is illustrated shaded.

The electrodes are connected via an electrolyte layer which completely covers the electrodes (not illustrated). During operation, the ions in the immediate vicinity of the gap first of all migrate from one electrode to the other. This results in a charge gradient within the electrodes. The longer the battery is operated, the further the distances the ions have to travel over. The shortest ion path from the point 104 on the boundary line of the positive electrode 101 to the negative electrode 102, therefore, corresponds to the sum of the width bₖ of the positive electrode and the gap width s. The internal resistance of the battery rises sharply.

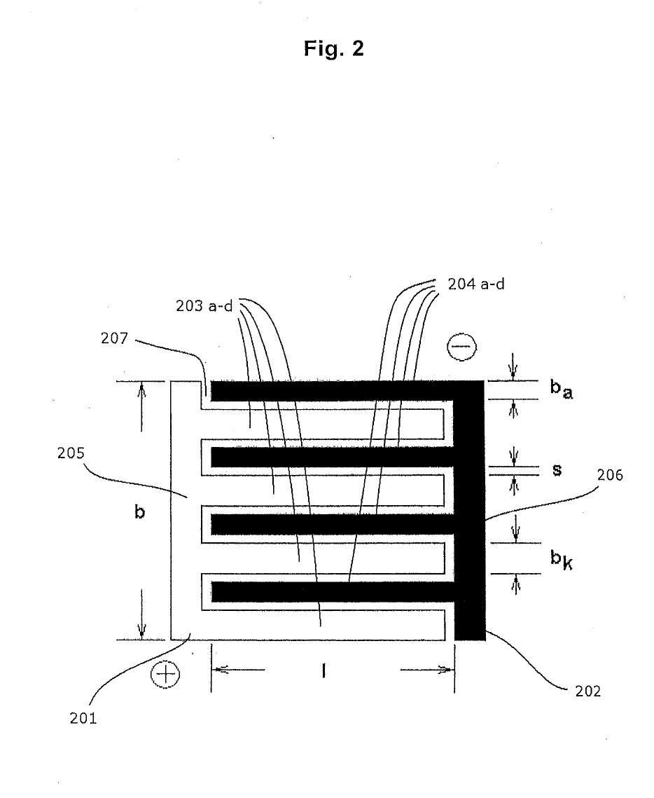

FIG. 2 shows an example of the electrodes 201 and 202 of our battery with a pattern in the form of a comb (schematic illustration). The electrodes 201 and 202 each comprise a plurality of sections 203a to 203d and 204a to 204d, which are in the form of strips and are arranged parallel to one another. These are in each case integrally formed on common lateral webs 205 and 206 which are aligned orthogonally to the strips and are likewise in the form of strips or ribbons. Overall, this, therefore, results in a “comb-like” configuration. The electrodes are arranged “engaging in one another” on the substrate. In this case, the lateral webs 205 and 206 are arranged parallel to one another, with a strip of the electrode of opposite polarity in each case coming to rest between two strips of one electrode arranged in parallel. The electrodes 201 and 202 are separated by a gap 207. This is defined by the mutually facing parts of the boundary lines of the electrodes 201 and 202. The gap width is essentially constant over the entire length of the gap. In its entirety, and like the boundary lines which define it, the gap itself has a rectangular profile, and, therefore, a non-linear profile, although it comprises a plurality of linear subsections (5 sections with the length 1, in each case 4 sections with the lengths bₐ and bₖ).

In comparison to the electrodes of a battery such as that illustrated in FIG. 1, the advantage of a configuration of the electrodes such as this is that the ratio of the length of the gap 207 between the electrodes 201 and 202 to the area of the electrodes is greatly increased, which in turn makes it possible to reduce the average distance which the ions have to travel over from one electrode to the others.

Positive and negative electrodes each have the same thickness. However, the positive electrodes occupy more area than the negative electrodes. The sections 203a to 203d and 204a to 204d in the form of strips all have the same length, but have different widths (bₐ <bₖ). The ratio of the thickness of the two electrodes 201 and 202 to the width of the gap is between 1:10 and 10:1.

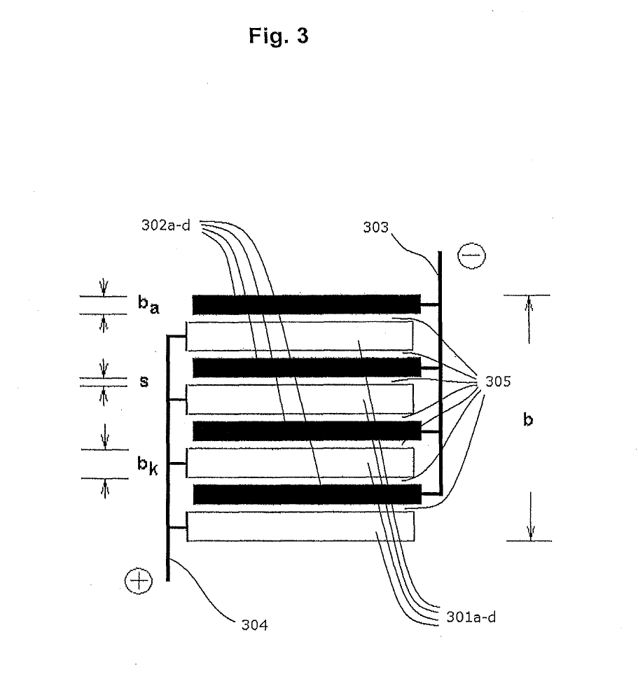

FIG. 3 shows an example of the electrodes of our battery in a configuration in the form of strips (schematic illustration). Four positive electrodes 301a to 301d and four negative electrodes 302a to 302d are each arranged parallel to one another and in an alternating sequence (alternately positive and negative). Electrodes of the same polarity are each connected via the output conductors 303 and 304. There is a gap 305 with a constant gap width s between each of the adjacent electrodes. Positive and negative electrodes each have the same thickness. The ratio of the thickness of the electrodes to the width of the gap s is 1:10 to 10:1.

The positive electrodes occupy more area than the negative. The sections 301a to 301d and 302a to 302d in the form of strips all have the same length but have different widths (bₐ<bₖ).

This example also ensures that the ratio of the overall length of the gaps 305 between the electrodes to the area of the electrodes is greatly increased.

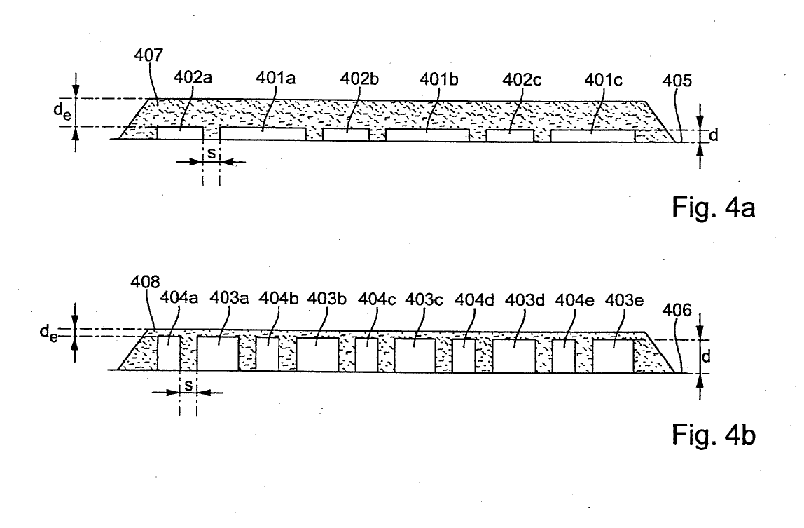

FIG. 4 shows two examples A and B of our battery (cross section, schematic illustration). The battery according to example A comprises the positive electrodes 401a to 401c and the negative electrodes 402a to 402c. The battery according to example B comprises the positive electrodes 403a to 403e and the negative electrodes 404a to 404e. The electrodes are in this case arranged on the substrates 405 and 406 as illustrated in FIG. 3, that is to say in the form of strips arranged parallel to one another. Gaps with the constant gap width s are located between each of the electrodes. The electrodes are covered by an electrolyte 407 and 408, which in each case also fills the gaps between the electrodes. The electrodes 401a-c and 402a-c differ from the electrodes 403a-e and 404a-e in their thickness. The thickness of the electrodes in example A therefore corresponds approximately to the gap width s, while in contrast to example B, the electrodes are thicker than the width of the gap by a factor of 2.

In general, batteries in example B have a higher current load capability than batteries in example A, as well as a comparatively lower internal resistance during operation. This is due, in particular, to the fact that, in example B, the majority of the ions can migrate via the electrolyte in the gap between the electrodes.

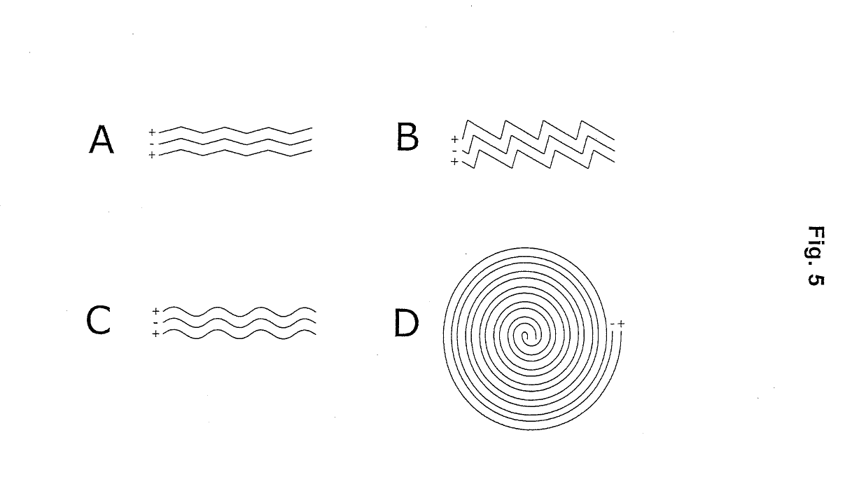

FIG. 5 shows possible refinements of the electrodes of our battery. As mentioned above, there are no restrictions on the shape of the electrodes when printing batteries. Correspondingly, it is possible without any problems to produce patterns in which electrodes in the form of strips have a triangular (A), sawtooth (B), wave (C) or spiral (D) geometry.

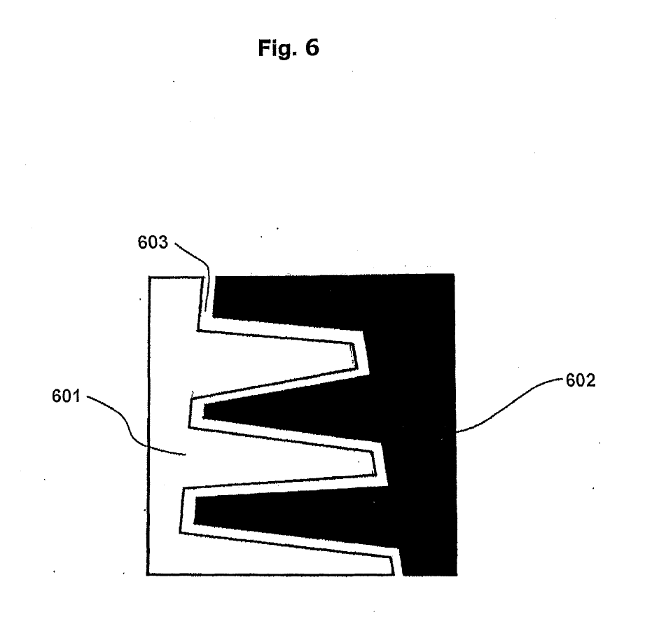

FIG. 6 shows a further example of the electrodes of our battery in a pattern in the form of a comb (schematic illustration). The illustration shows a positive (white) and a negative electrode 601 and 602. The electrodes are separated by the gap 603. In contrast to the electrode pattern in the form of a comb in FIG. 2, the horizontally aligned electrode strips as well as the vertical webs do not have a uniform width, however, and instead they are wedge-shaped or trapezoidal. This can likewise have a positive influence on the internal resistance.

### Example

The following procedure was used to produce a battery system as shown in FIG. 4B.

First, a plastic film was provided as a substrate, and a further plastic film as a cover film. In principle, plastic films with low gas and water-vapor diffusion rates are preferred for this purpose, that is to say in particular films composed of PET, PP or PE. Particularly suitable films are described in WO/2009/135621. If the intention is to subsequently heat-seal these films to one another, the basic films which are provided can additionally be coated with a further material having a low melting point. Suitable fusion adhesives are known.

An output-conductive structure was then first of all applied to the substrate. A conductive lacquer containing silver was printed on for this purpose. Alternatively, for example, it is also possible to use conductive adhesives based on nickel or graphite, which can likewise be printed on. Furthermore, of course, it is also possible to produce the required output conductors electrochemically or by deposition from the gas phase. All of these processes are known.

The electrode material for the positive electrode was then printed onto the appropriate collector/output conductor. This printing takes place with a screen-printing machine. The electrode material used was a paste which consisted of an electrically active material such as MnO₂ (308 mAh/g), a binding agent, a conductive material (graphite or carbon black) and a solvent. The negative electrode was also produced in an analogous manner. This was done using a paste consisting of an electrically active material such as zinc powder (820 mAh/g), a binding agent and a solvent.

The electrodes were printed in uniform strips with a length of 30 mm, the positive with a width of 0.23 mm and the negative with a width of 0.07 mm. The gap between electrodes had a width of 0.1 mm. After drying, the electrodes (positive and negative) had a thickness of about 190 μm.

Finally, the electrolyte was applied in a further method step. The electrolyte is preferably an aqueous (KOH, ZnCl₂) or organic solution of conductive salts, which provide the ions for the current flow. The electrolyte was likewise applied by a printing method. The electrolyte completely covered the electrodes illustrated in FIG. 4B. The gaps between the electrodes were completely filled with electrolyte, and the thickness of the electrolyte layer over the electrodes was 10 μm.

The single cell produced in this way was then covered with the further plastic film, that is to say was closed in the form of a housing. This was done using a hot-sealing method.

The resultant battery had an initial internal resistance of 2 ohms. During operation, this resistance increased up to 13 ohms. A battery with electrodes with a thickness of only 50 μm and an electrolyte layer with a thickness of 150 μm over the electrodes (and otherwise identical parameters) had an internal resistance of 2 ohms initially, although this increased up to 18 ohms during operation.

1. A battery comprising a flat positive and a flat negative electrode separated by a gap, arranged alongside one another on a flat substrate and connected to one another via an ion-conducting electrolyte, wherein a ratio of thickness of at least one of the electrodes to a minimum width of the gap is 1:10 to 10:1.

2. The battery as claimed in claim 1, wherein the gap between the electrodes has an essentially uniform gap width.

3. The battery as claimed in claim 1, wherein the positive and negative electrodes have essentially the same thickness.

4. The battery as claimed in claim 1, wherein the positive electrode occupies a larger area on the substrate than the negative electrode.

5. The battery as claimed in claim 1, wherein the electrodes are in the form of strips, at least in subareas.

6. The battery as claimed in claim 5, wherein the strips have an essentially uniform width.

7. The battery as claimed in claim 1, wherein areas which the electrodes occupy on the substrate are each defined by a circumferential boundary line, and in for each of the electrodes, at least part of a boundary line faces an electrode of opposite polarity, with a quotient of a length of that part of the boundary line of the electrode which faces the electrode of opposite polarity to an overall length of the boundary line is 0.25 to 0.5.

8. The battery as claimed in claim 5, wherein a ratio of a width of the strips to a width of the gap between the electrodes is 0.5:1 to 20:1.

9. The battery as claimed in claim 5, wherein the ratio of a length of the strips to their width is 2:1 to 10 000:1.

10. The battery as claimed in claim 1, further comprising more than one positive electrode and/or more than one negative electrode.

11. The battery as claimed in claim 1, wherein the electrodes are printed onto the substrate.

12. The battery as claimed in claim 5, wherein the strips have a rectangular, triangular, wave-like, spiral or sawtooth-like profile at least in one subarea.
